(19) United States
(12) Patent Application Publication
(10) Pub. No.: US 2017/0244267 A1
(43) Pub. Date: Aug. 24, 2017

(54) SMART ANTI -THEFT ADAPTER WITH DUAL POWER MODE

(71) Applicant: GYAN PRAKASH KESARWANI, DELHI (IN)

(72) Inventor: GYAN PRAKASH KESARWANI, DELHI (IN)

(21) Appl. No.: 15/439,960

(22) Filed: Feb. 23, 2017

(30) Foreign Application Priority Data
Feb. 23, 2016 (IN) 201613006305

(51) Int. Cl. H02J 7/00; G08B 13/22; H02J 9/06

(52) U.S. Cl. CPC H02J 7/0052; H02J 9/061; H02J 7/0044; G08B 13/22; H02J 2007/0059

(57) ABSTRACT

The various embodiments herein disclose an anti-theft charging adapter for electronic device to enhance a battery backup capacity of a load electronic device. The charging adapter comprises an adapter circuit and a supplementary power supply unit. The adapter circuit comprises a voltage translator and a current converter. The supplementary power supply unit comprises a processor, a secondary power source, a charger display, a Global Subscriber Module (GSM), an anti-theft module and a GSM activation switch. The secondary power source charges simultaneously during a charging cycle of the load device. The secondary power source act as a primary power source when the main power supply is switched off. The secondary power source supplies the stored power to the load device when a voltage of the load device is lower than the voltage of the secondary power source.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever, Copyright, Designs and Patents Act 1988.

### CROSS REFERENCE TO RELATED APPLICATION

This application claims priority to and the benefit of Indian application No. 201613006305 filed on Feb. 23, 2016 titled “SMART ANTI-THEFT ADAPTER WITH DUAL POWER MODE”; the disclosure of which is incorporated herein by reference in its entirety.

### TECHNICAL FIELD

The present invention generally relates to electronic equipment and particularly relates to a power adapter. The present invention more particularly relates to a power adapter with anti-theft unit for detecting the location of the device. The present invention more particularly relates to anti-theft power adapter with dual power mode that facilitates a user to charge a load (or any chargeable/re-chargeable electronic device) even in absence of a main power supply. The present invention more particularly relates to a power adapter with a secondary power supply and an anti-theft unit to detect the position of a corresponding mobile or Smartphone or tablet. The present invention more particularly relates to a smart power charger with Unique ID (UID).

### BACKGROUND

A battery charger or recharger is a device used to put energy into a secondary cell or rechargeable battery by forcing an electric current through it. The batteries used for mobile phones generally charge a load device at a given voltage which is much less than the supplied main power. Thus through an adapter this voltage transition is facilitated. But present single charger charges till a duration when the battery of a mobile is full or main power supply is switched off.

One of the prior arts discloses a mobile charger device including a first connector that electrically connects a first mobile device to the mobile charger device, a second connector that electrically connects a second mobile device to the mobile charger device, a connector that electrically connects the first mobile device electrically connected by the first connector with the second mobile device electrically connected by the second connector, and a switch operable to select which one of the first and second mobile devices supplies power through the connector element to the other of the first and second mobile devices.

Another prior art discloses a mobile charger includes a housing. A cell is provided in the housing. A positive power distribution unit and a negative power distribution unit are provided at both ends of the housing relative to the positive and the negative poles of the cell, respectively. A conducting piece set is provided in the housing. The conducting piece set is connected to the positive power distribution unit and the negative power distribution unit. A charging unit and a power supplying unit are provided in the housing. The charging unit and the power supplying unit are electrically connected with the positive pole of the cell through the positive power distribution unit and the conducting piece set and electrically connected with the negative pole of the cell through the negative power distribution unit. Thus, the cell is charged with direct current which is converted from alternating current through an AC charger by the charging unit, and then direct current is outputted from the cell through the power supplying unit, so as to provide sufficient electric power to an electronic product which needs to use a DC power supply at anytime and anywhere.

However, the prior arts are limited to the scenario that if a main power supply is switched off then charging of a load or a chargeable electronic device also stops. Thus the present charger or charging adapters in the prior arts fails to charge a mobile phone during power outage. Also the prior art charger are limited in functionalities to charging a battery in the presence of main power supply and lacks in assisting to track an electronic device, display the status of a mobile battery and other information. The prior arts do not provide a charger with tracking facility for preventing theft. The present invention provides a smart charger with additional security features such as Unique ID (UID) based facility for assisting the user to navigate or track the lost electronic device.

In the view of foregoing, there is a need for a charging adapter that supplies power to a connected load, especially a mobile phone during a power outage. Also there is a need for a smart anti-theft power adapter that can track the location of a linked electronic device along with displaying a plurality of information.

The above mentioned shortcomings, disadvantages and problems are addressed herein, as detailed below.

### OBJECTS OF THE INVENTION

The primary object of the present invention is to provide a smart anti-theft charger with a secondary power supply unit.

Another object of the present invention is to provide an electronic circuit in the secondary power supply that is capable of holding charge during charging of a connected load or an electronic device through a main power supply without hampering a charging cycle of the load.

Yet another object of the present invention is to charge the load or electronic device through the secondary power supply during absence of the main power supply.

Yet another object of the present invention is to controllably and securely interact with a registered electronic device paired through Unique ID.

Yet another object of the present invention is to provide a smart anti-theft battery adapter with a screen to display a plurality of information such as (but not limited to) the location of the paired device from time to time.

Yet another object of the present invention is to provide a smart anti-theft battery adapter for sharing paired device information among a number of computing devices in a network via wired or wireless communication medium.

These and other objects and advantages of the embodiments herein will become readily apparent from the following detailed description taken in conjunction with the accompanying drawings.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure finds particular application in managing and displaying security or tracking related information through various networks, specifically wireless networks, on the computing devices in a network, and will be described with particular reference thereto. However, it is to be appreciated that the present disclosure is also amenable to other like applications.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

Non-Limiting Definitions: In various embodiments of the present disclosure, definitions of one or more terms that will be used in the document are provided below:

As used herein, an “electronic device” or “mobile” as used herein includes a single device capable of communicating, and exchanging one or messages with other devices present in a network. The electronic device or mobile is also configured to connect to the network such as the Internet.

As used herein, a smart anti-theft battery adapter for “sharing” is a device configured to transmit or receive data, files, and images to and from computing device in the network. The sharing process can utilize the functionality of hardware, software, firmware, and combination of these.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

As disclosed herein, APK can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Further, as used herein, a “storage device” refers to a device including hardware, software, firmware, or combination of these that can be configured to store the one or more multimedia messages and a plurality of hashtags.

Further, as used herein, a “paired device” refers to a device including hardware, software, firmware, or combination of these. Further, the paired device can connects the smart charger and the electronic device.

Overview : The various embodiments of the present invention disclose a charging adapter unit to enhance a battery back-up capacity of a load device. The charging adapter unit comprises an adapter circuit unit, a slot to connect a secondary power source and a means for cooling the adapter circuit unit and the secondary power source like ventilation means to circulate air. The cooling means can be temperature control module (chip or microprocessor) also, which disconnects the circuit after reaching a certain temperature to help in cooling by different modes like radiation etc. The adapter circuit unit comprises a voltage translator and a current converter. The voltage translator shifts a voltage level received from a main power supply. The current converter works in conjunction with the voltage translator to convert and Alternating Current to a Direct Current. The secondary power source is connected to the adapter circuit unit through the slot. The secondary power source is charged simultaneously with a load battery or a handheld device battery. The secondary power source acts as a primary power source or supply source in absence of a main power supply. Further, the smart charger comprises of unique ID which helps in pairing with corresponding devices. The device which are to be paired are connected to the charger through the unique ID. The unique ID which pairs the charger and the device helps in detecting the movement of the paired device in case of theft or displacements. The smart charger connects the paired devices with at-least one (1) other devices for notification or tracking and sends alert messages to the other devices regarding the status of the lost paired device. The other devices are also connected with the smart charger through unique ID or any other means.

According to one embodiment herein, the handheld electronic device belongs to a group of processing devices. The group of processing devices comprises but not limited to a mobile phone, a smartphone, a tablet, a phablet, a laptop and a handheld gaming console.

According to one embodiment herein, the secondary power source is a high capacity rechargeable battery.

According to one embodiment herein, the secondary power source is a capacitor with charge storage capacity higher than the storage capacity of the load device.

The embodiments herein disclose a charging adapter to enhance a battery backup capacity of a load device. The charging adapter comprises an adapter circuit unit and a supplementary power supply unit. The adapter circuit comprises a voltage translator and a current converter. The supplementary power supply unit comprises a processor, a secondary power source, a charger display, a Global Subscriber Module (GSM) and a GSM activation switch. The secondary power source charges simultaneously during a charging cycle of the load device. The secondary power source act as a primary power source or supply source when the main power supply is switched off. The secondary power storage source supplies the stored power to the load device when a voltage of the load device is lower than the voltage of the secondary power source.

According to one embodiment herein, the load device belongs to a group of processing devices. The group of processing devices comprises a mobile phone, a smartphone, a tablet, a phablet, a laptop and a handheld gaming console.

According to one embodiment herein, the secondary power source is a high capacity rechargeable battery.

According to one embodiment herein, the secondary power source is a capacitor with charge storage capacity higher than the storage capacity of the load device.

According to one embodiment herein, the secondary power source is connected in series with the adapter unit. The secondary power source is connected to a user's mobile device in parallel.

According to one embodiment herein, the secondary power source is removable in nature i.e. a user selects his or her choice of battery and places it into a secondary power source slot optionally provided in the charger.

An embodiment herein discloses a method for detecting a mobile's location through an intelligent charging adapter comprising the steps of providing a unique identification number (UIN) with to each piece of the intelligent charging adapter. The UIN is associated with an Intermediate Mobile Station Equipment Identity (IMEI) number or other specific identification number (SIN) of a mobile phone or electronic device. A microprocessor for processing and a storage unit to store an associated UIN and IMEI/SIN in a Look-Up Table (LUT). A GSM module is activated to track a lost mobile/electronic device. The lost mobile's IMEI/Electronic device's SIN is associated with UIN of the intelligent charger. A last geo-location of the lost mobile/electronic device plugged to a charger with an unassociated UIN or without a UIN is displayed on a display screen of the charger.

According to one embodiment herein, the LUT further contains information pertaining to a list of associated and unassociated IMEIs/SINs, time of the lost mobile/device is connected with to a charger with an unassociated UIN and geo-location of the lost mobile/device.

According to one embodiment herein, the LUT is dynamically updated on authorization of a user. The user authorizes to update the LUT through a code entered and accepted only on a peer server. The peer server is a server managed by a manufacturer of the charger, wherein a user authorizes the update through his or her registered account. A registered account of a user is created at the time of sale of the charger.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 illustrates a block diagram of architecture of the intelligent charger, according to one embodiment herein;

FIG. 2 illustrates a block diagram of an alternate architecture of the intelligent charger, according to one embodiment herein;

FIG. 3A illustrates a front view of the intelligent charger, according to one embodiment herein;

FIG. 3B illustrates a side view of the intelligent charger, according to one embodiment herein;

FIG. 4 illustrates the process for installing the anti-theft application and the procedure to connect the user with the system;

FIG. 5 illustrates the charger connecting process flow chart;

FIG. 6 illustrates the process for deleting the data from the lost device.

### DETAILED DESCRIPTION OF THE INVENTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

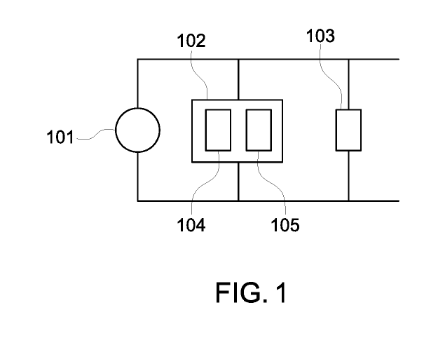

FIG. 1 illustrates a block diagram of architecture of the intelligent charger, according to one embodiment herein. With respect to FIG. 1, the charging adapter 100 comprises comprising an adapter circuit 102, a slot to connect a secondary power source 103 and a means (not shown) for cooling the adapter circuit and the secondary power source. The adapter circuit 102 comprises a voltage translator 104 and a current converter 105. The voltage translator 104 shifts a voltage level received from a main power supply 101. The current converter 105 works in conjunction with the voltage translator 104 to convert and Alternating Current to a Direct Current. The secondary power source is connected to the adapter circuit through the slot 103. The secondary power source is charged simultaneously with a load battery or a handheld device battery. The secondary power source acts as a primary power source in absence of a main power supply 101.

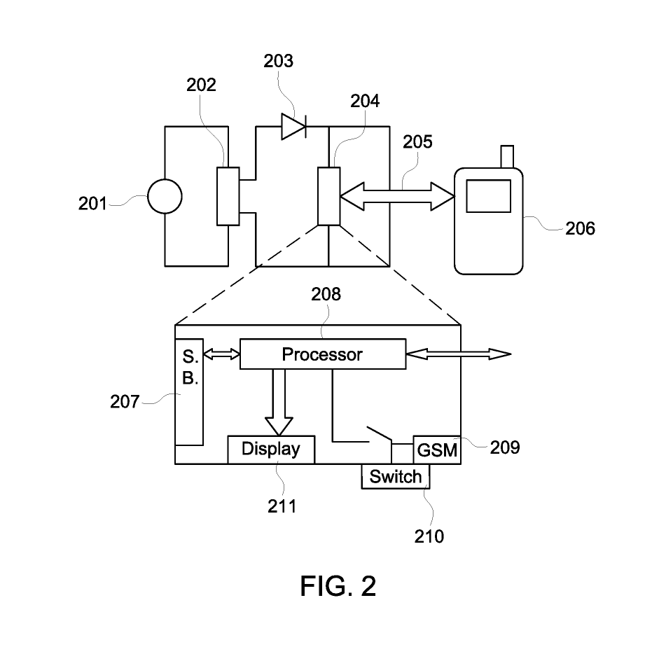

FIG. 2 illustrates a block diagram of an alternate architecture of the intelligent charger, according to one embodiment herein. With respect to FIG. 2, the intelligent battery charger comprises an adapter circuit 202. The adapter circuit 202 converts a fluctuating 220V alternating current from the main power supply 201 to a 12V Direct Current used to charge a load or a mobile battery 206. The adapter circuit 202 is further connected to the supplementary power supply unit 204 through a diode 203. The supplementary power supply unit 204 comprises a processor 208, a secondary power source 207, a charger display 211, a Global Subscriber Module (GSM) 209 and a GSM activation switch 210. The secondary power source 207 is connected to the main power supply 201 in parallel with adapter circuit 202. The secondary power source 207 acts as main power source in the absence of the main power supply unit 201. In this case both the adapter circuit 202 and the mobile 206 battery act as a load. To avoid a power flow towards the adapter circuit 202, the diode 203 is placed in the path that prevents a reverse current flow in absence of the main power supply 201.

The processor 208 is a specifically a 8-pin microprocessor or microprocessor unit. The secondary power source 207 is connected to the Vcc pins of the processor 208. The GSM activation switch 210 forms a unidirectional switch that connects/disconnects the GSM unit 209 with the processor 208. The GSM unit 209 is connected bi-directionally to an input pin and an output pin of the processor 208. The display unit 211 is connected to an output pin of the processor 208. The load device 206 is connected to an output pin and an input pin the processor 208 through a bi-directional bus 205. The bi-directional bus 205 is a Universal Serial Bus.

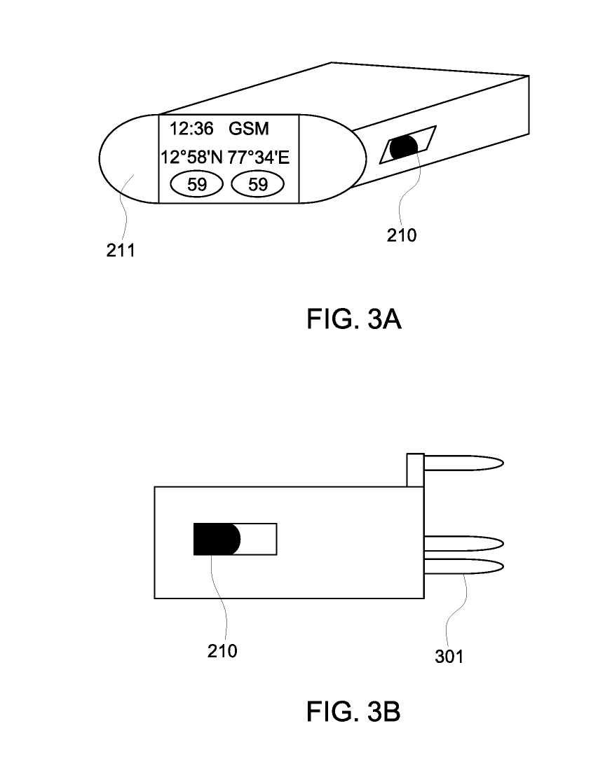

FIG. 3A illustrates a front view of the intelligent charger, according to one embodiment herein. With respect to FIG. 2A, the display unit 211 shows a current time, a current date, a battery level of the mobile battery when it is connected for charging, a battery level of the secondary power source and a green or red light corresponding to on and off status of the GSM switch 210. The display unit 211 changes its colour on detecting a geo- location of a stolen mobile.

FIG. 3B illustrates a side view of the intelligent charger, according to one embodiment herein. With respect to FIG. 2B, the side view comprises the GSM switch 210 and a 3 power pins 301.

According to an embodiment herein, the secondary power source acts as a load when connected to the main power and charges simultaneously with the mobile battery. The secondary power source acts as a source and charges the mobile battery till booth the battery level becomes equal. For e.g. after removing the main power supply the battery level of the secondary power source and the mobile battery is 100% and after a period of time the mobile battery is down to 53%. Then, a user directly plugs the charger to the mobile and the mobile battery will start charging through the secondary because secondary power source is at high potential. When the mobile battery level and secondary power source level reaches at same value i.e. 76.5%. The charger continuously shows an increasing of the mobile battery's level and decreasing of the secondary power source's level over the display.

According to an exemplary embodiment, the user creates a profile and registers an IMEI number of the mobile phone and a UIN of the battery in the profile and saves the information. The GSM module has functionality of sending and receiving information only to and from the mobile number with correlated IMEI number. As soon as, a mobile is lost the user activates the GSM module of the charger by pushing the GSM switch from “OFF” to “ON” position. As the GSM module is activated it initiates a ping to the server as well as the mobile phone. The GSM module continuously pings the mobile phone at every interval of 60 seconds. As soon as, the mobile phone is plugged to a charger with a charger with unrelated UIN or without an UIN, it receives a ping from the correlated battery charger. In return, the GSM reply with an acknowledgement and this process continues till the server tracks a geo-location of the mobile phone. The tracked geo-location is sent to the battery charger and the charger shows the notification of the found mobile through a faint red display. The user extracts the geo-location by logging to the server and reading a recent notification.

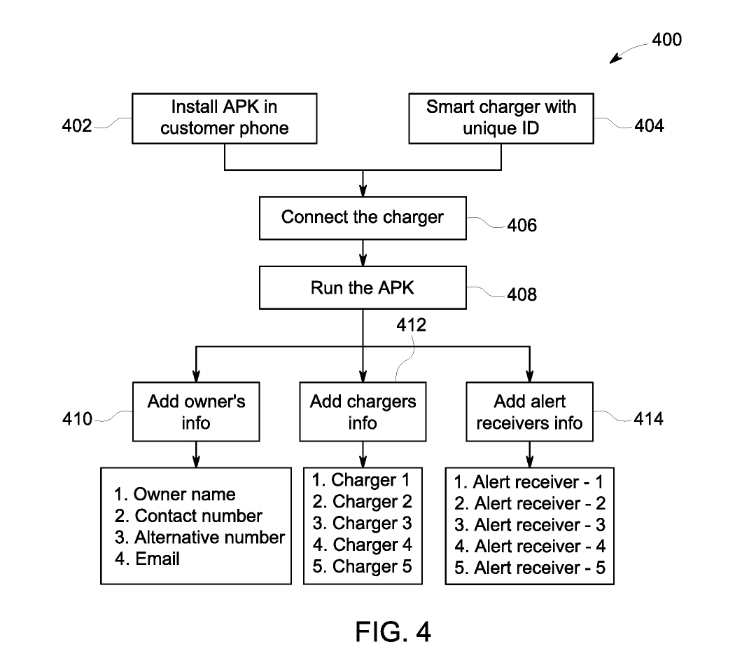

FIG. 4 illustrates the anti-theft unit's process for installing the anti-theft application and the procedure to connect the user with the smart charger (400). The customer will have to install the Android application package (APK) or any other platform application package in mobile phone/electronic device (402) and then connect the smart charger with unique identification number (UIN) to the phone/device (404). Once the charger is connected (406) with the smart charger run the APK (408). The installation and run of the APK application will require the customer to enter the details of the owner (410) which comprises owners name, contact number, alternative number and email address. The smart charger require to add charger information (412), maximum five chargers can be added to the smart charger. The customer will have to further feed alerts receivers' information (414), maximum five alert receivers can be added to the smart charger.

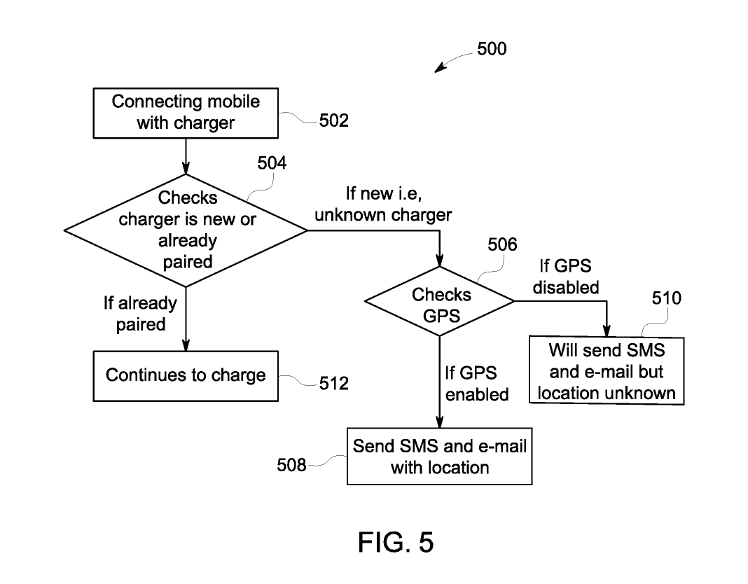

FIG. 5 illustrates the charger connecting process as illustrated in FIG. 500. The customer/user should connect the mobile/device with unique identification number (UIN) charger for pairing (502), if not already paired. If the charger is already paired then it starts charging the device (512), however if not paired already and is a new charger then the customer will have to enter the password in 20 seconds. If the password matches then the new charger will be added and in case the password doesn't match the application checks the GPS (506), if the GPS is enabled then the SMS and email will be sent with location details to the alerts receivers (508). However, if the GPS is disabled then the SMS and email will be sent to the alert receivers without location details (510). Once the alerts are received by the alert receivers then the mobile can be tracked by the location details.

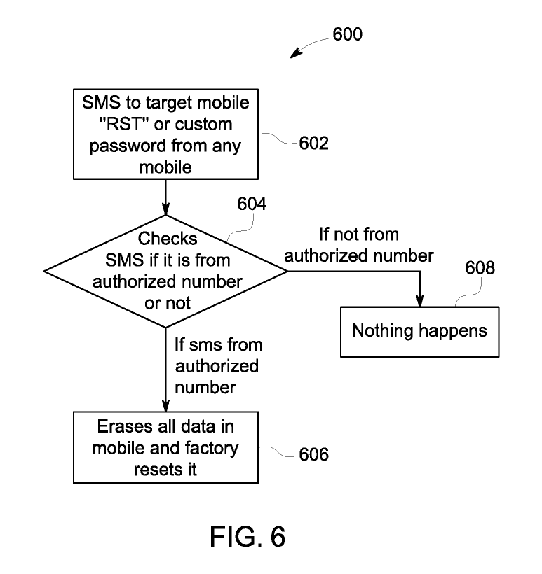

FIG. 6 illustrates the process 600 for deleting the data by the user in case the lost device is not recovered. In the event the GPS is off and the location cannot be tracked the user can delete and protect the data from becoming public. SMS is sent (602) to any of the mobile numbers registered in the application (604) and once the SMS is received in the lost device it will start erasing the data stored in mobile device and SD card (606) which ultimately prevents misuse of the stored data.

The smart charger in the present invention provides a mobile charging during travel or a place with unavailability of the main power supply. The smart charger also displays a plurality of useful information over its display unit. The smart charger also provides an anti-theft feature against the mobile phone theft.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims presented in the complete specification or non-provisional application.

1. A charging adapter unit to enhance a capacity of a load device comprising:
an adapter circuit unit, wherein the adapter circuit unit comprises:
a voltage translator, wherein the voltage translator shifts a voltage level received from a main power supply;
a current converter, wherein the current converter works in conjunction with the voltage translator to convert and Alternating Current to a Direct Current;
a slot to connect a secondary power source, wherein the secondary power source is connected to the adapter circuit through the slot;
a means for cooling the adapter circuit and the secondary power source;
wherein the secondary power source is charged simultaneously with a load battery or a handheld device battery, wherein the secondary power source acts as a primary power source in absence of a primary power supply;
an anti-theft unit, where is the anti-theft unit comprises:
a unique identification number (UIN), wherein UIN is used to provide unique identity to the charging unit;
a pairing means, wherein the pairing means associates the UIN with an Intermediate Mobile Station Equipment Identity (IMEI) number of a mobile phone or Specific Identification Number (SIN) of an electronic device;
a storage unit, wherein the storage unit stores an associated UIN and IMEI/SIN in a Look-Up Table (LUT);
a microprocessor unit, wherein the microprocessor unit processes an associated UIN and IMEI/SIN in a Look-Up Table (LUT);
a GSM module, wherein the GSM module tracks a lost device, wherein the lost device's IMEI/SIN is associated with UIN of the charging unit; and,
a transceiver unit, wherein the transceiver unit sends/receives data from other electronic device in a network.

2. The charging adapter as per claim 1, wherein the charging adapter optionally comprises a display screen for displaying the paired device information.

3. The charging adapter as per claim 1, wherein the handheld device belongs to a group of processing devices, wherein the group of processing devices comprises a mobile phone, a smartphone, a tablet, a phablet, a laptop and a handheld gaming console.

4. The charging adapter as per claim 1, wherein the secondary power source in a high capacity rechargeable battery.

5. The charging adapter as per claim 1, wherein the secondary power source is a capacitor with charge storage capacity higher than the storage capacity of the load device.

6. A charging adapter unit to enhance a battery backup capacity of a load device comprising:
an adapter circuit, wherein the adapter circuit comprises a voltage translator and a current converter;
a secondary power supply unit, wherein the secondary power unit comprises:
a processor;
a secondary power source;
a charger display;
a Global Subscriber Module (GSM);
a GSM activation switch;
a power storage unit;
wherein, the secondary power source charges simultaneously during a charging cycle of the load device, wherein the secondary power source as a power source when the main power supply is switched off, wherein the secondary power source supplies the stored power to the load device when a voltage of the load device is lower than the voltage of the secondary power source.

7. The charging adapter as per claim 5, wherein the load device belongs to a group of processing devices, wherein the group of processing devices comprises mobile phone, smartphone, tablet, phablet, laptop and handheld gaming console.

8. The charging adapter as per claim 5, wherein the secondary power source is a high capacity rechargeable battery.

9. The charging adapter as per claim 5, wherein the secondary power source is a capacitor with charge storage capacity higher than the storage capacity of the load device.

10. The charging adapter as per claim 5, wherein the secondary power source is connected in parallel with the adapter unit and to a user's mobile device in parallel.

11. The charging adapter as per claim 5, wherein the secondary power source is removable in nature.

12. A method for detecting a mobile device location through an intelligent charging adapter unit comprising the steps of:
providing a unique identification number (UIN) with to each piece of the intelligent charging adapter;
associating the UIN with an Intermediate Mobile Station Equipment Identity (IMEI) number of a mobile phone, wherein a microprocessor stores an associated UIN and IMEI in a Look-Up Table (LUT);
activating a GSM module to track a lost mobile, wherein the lost mobile's IMEI is associated with UIN of the intelligent charging adapter unit;
displaying a last geo-location of the lost mobile plugged to a charger with an unassociated UIN or without a UIN;
sending a notification to the lost device after tracking, wherein once the notification is received by the lost mobile it automatically starts deleting stored data in the mobile device's memory and SD card.

13. The method as claimed in claim 11, wherein the LUT further contains information pertaining to a list of associated and unassociated IMEIs, time of the lost mobile device is connected with to a charger with an unassociated UIN and geo-location of the lost mobile device.

14. The method as claimed in claim 11, wherein the LUT is dynamically updated on authorization of a user, wherein the user authorizes to update the LUT through a code entered and accepted only on a peer server, wherein the peer server is a server managed by a manufacturer of chargers, wherein a user authorizes the update through his or her registered account, wherein the registered account of the user is created at a time of sale of any charger.
